(19) United States
(12) Patent Application Publication
(10) Pub. No.: US 2009/0169292 A1
(43) Pub. Date: Jul. 2, 2009

(54) Articulating Handle Assemblies for Cleaning Tools and Methods of Use

(76) Inventors: Phillip LeCompte, Lomita, CA (US); Mary Taylor, Redondo Beach, CA (US)

Correspondence Address: HENRICKS SLAVIN AND HOLMES LLP;SUITE 200, 840 APOLLO STREET, EL SEGUNDO, CA, 90245, US

(21) Appl. No.: 11/967,195

(22) Filed: Dec. 29, 2007

(51) Int. Cl. F16C 11/00

(52) U.S. Cl. 403/100; 403/119

(57) ABSTRACT

And adapter for a mop includes first and second linear elements with a hinge element between them. The first linear element includes a pair of connection elements for a mop head adapter allowing the mop head adapter to take a first configuration and allowing the mop head adapter to take another second configuration. The configurations can position the mop head adapter at positions perpendicular to each other. The hinge element may include a locking element. The hinge element can be locked at a number of positions.

### BACKGROUND

1. Field

These inventions relate to mop and cleaning equipment handles and adapters.

2. Related Art

A number of manufacturing, testing and medical facilities require controlled environments. For example, manufacturing and fabrication of some instruments and electronic parts are carried out in highly controlled environments commonly called clean rooms. Clean rooms are also used in the production of pharmaceuticals and in the manufacture or assembly of medical instruments.

Clean rooms require regular cleaning, as do other manufacturing, testing and medical facilities, but such cleaning must often be done in such away as to eliminate or prevent contamination of surfaces by particles or biologic material having a size greater than five microns at concentrations or densities greater than 3000 particles per cubic meter. As a result, special cleaning equipment and procedures are used. Additionally, because contamination of one surface may lead to contamination of adjacent surfaces, such as through air flow and/or personnel movement, more exposed surfaces require cleaning than in other manufacturing, testing and medical facilities. Walls and ceilings require cleaning, in addition to work surfaces, floors, shelves and equipment.

Clean rooms may also include isolators in which materials are prepared, mixed or analyzed while isolating the materials from the technician or operator. Such isolators are common and can be formed from sealed cabinets having special access chambers, glove fittings and filtration systems. Isolators also require cleaning equipment suitable for such enclosures, in addition to meeting special requirements restricting contamination, such as non-linting materials, no lubricants, and the like.

### SUMMARY

One or more aspects of the present inventions can be used to provide a mop adapter that is easier to use, and that can be used in a larger variety of applications. The mop adapter can meet required specifications omitting lubricants and limited production/creation of particulates during normal use. Aspects of the present inventions may be used to provide an improved mop adapter in accordance with one or more examples as described herein.

In one example of an adapter, first and second linear elements are provided and connected together using a hinge element. The first linear element includes at an end portion spaced from the hinge element a pair of connection elements configured to allow connection of a mop head adapter in first and second orientations. In one example, the first orientation may be parallel to an axis of the hinge element, and the second orientation may be perpendicular to an axis of the hinge element. In one configuration, the adapter can also have connection elements on an end of the second linear element spaced from the hinge element. Additionally, the connection elements on the second linear element can be arranged parallel to a hinge axis. In a further configuration, the adapter can include a locking element. The locking element can lock the first and second linear elements relative to each other. The locking element can be incorporated into the hinge element. The first and second linear elements can be locked at a number of angles, for example 90 degrees, 135 degrees, 150 degrees or 180 degrees. The locking element can be a pin fixing the hinge element in position. The locking element can also be a threaded bolt, a thumb screw or a wing nut.

In another example of an adapter, the adapter can include first and second tubular elements coupled together with a hinge element. The first tubular element can include first and second pairs of coupling elements in a second end portion, where the first and second pairs extend in directions substantially perpendicular to each other. A third pair of coupling elements is included in the second tubular element. In one configuration, the third pair of coupling elements is arranged substantially parallel to the pivot axis of the hinge element. The coupling elements in any of the pairs or all the pairs may be detent pins, push buttons or snap buttons. In another configuration, the first tubular element may be longer than the second tubular element. The hinge element may include a locking element configured to releasably lock the first and second tubular elements relative to each other. The locking element can lock the first and second tubular elements at a number of angles relative to each other.

In a further example of an adapter, first and second linear tubular elements are connected by a hinge assembly such that first and second hinge portions of the hinge assembly pivot relative to each other about an axis. A locking element is included in the hinge assembly and configured to lock first and second hinge portions of the hinge element relative to each other. In one configuration, the first and second linear tubular elements include respective pairs of connection elements arranged on respective lines substantially parallel to the axis. The first linear tubular element may also include a second pair of connection elements arranged on a line substantially perpendicular to the axis.

These and other examples are set forth more fully below in conjunction with drawings, a brief description of which follows.

### BRIEF DESCRIPTION OF THE DRAWINGS

FIG. 1 is a front elevation and partial schematic of an isolator that may be used in a cleanroom or other controlled environment.

FIG. 2 is a right side elevation of a mop adapter in accordance with one example of the present inventions.

FIG. 3 is a top plan view of the adapter of FIG. 2.

FIG. 4 is a bottom plan view of the adapter of FIG. 2.

FIG. 5 is a transverse cross-section of a tubular linear element of the adapter of FIG. 2.

FIG. 6 is a bottom plan view of the tubular linear element of the adapter of FIG. 2 with a portion of a hinge element.

FIG. 7 is a top plan view of another linear tubular element of the adapter of FIG. 2 with a portion of a hinge element.

FIG. 8 is an exploded view of another example of an adapter.

FIG. 9 is an isometric view of a fastener assembly for use with a hinge assembly on the adapter of FIGS. 2 and 9.

FIG. 10 is an exploded view of another example of an adapter.

FIG. 11 is an exploded view of another fastener assembly for use with a hinge assembly on the adapter of FIGS. 2 and 9.

FIG. 12 is a side elevation view of an adapter having linear elements positioned at a number of angles relative to each other representing exemplary angles at which the linear elements can be locked.

FIG. 13 is a side elevation view of a mop adapter with a mop head, mop head adapter and handle assembly combined with the mop adapter showing an example of an application for any of the mop adapters described wherein.

FIG. 14 is a side elevation view of the combination of FIG. 13 with the mop head and mop head adapter secured at a different orientation on the mop adapter compared to the assembly of FIG. 13.

FIG. 15 is a side elevation view of the combination of FIG. 14 showing a method of using the combination for cleaning a top of an isolator.

FIG. 16 is a side elevation view of the combination of FIG. 14 showing a method of using the combination for cleaning a bottom of an isolator.

FIG. 17 is a side elevation view of the assembly of adapters such as those shown in FIG. 2.

FIG. 18 is a side elevation view of the assembly of adapters of FIG. 17 in an extended configuration.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of cleaning tool adapters and of methods of making and using the cleaning tool adapters are described. Depending on what feature or features are incorporated in a given structure or a given method, benefits can be achieved in the structure or the method. For example, cleaning tool adapters that can be connected together may give better flexibility and ease of use when combined. Additionally, some cleaning tool adapter configurations may also allow users to stock fewer items for a given facility.

These and other benefits will become more apparent with consideration of the description of the examples herein. However, it should be understood that not all of the benefits or features discussed with respect to a particular example must be incorporated into a cleaning tool adapter, component or method in order to achieve one or more benefits contemplated by these examples. Additionally, it should be understood that features of the examples can be incorporated into a cleaning tool adapter, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of cleaning tool adapter configurations and of methods of making and using the cleaning tool adapters are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

It should be understood that terminology used for orientation, such as front, rear, side, left and right, upper and lower, and the like, are used herein merely for ease of understanding and reference, and are not used as exclusive terms for the structures being described and illustrated.

Mop adapters such as those described herein can be used in a number of applications. In addition to cleaning floors, walls, ceilings, counter tops and similar surfaces, the examples of mop adapters described herein can be used to clean a number of surfaces of isolators, such as isolators used in assembly, aseptic or clean fill operations, aseptic mixing applications, or other equipment. For example, isolators used in clean fill operations may extend the length of a room, extending from one wall where product components are introduced to another wall where filled and sealed or closed product from the isolator is passed out for further processing. Such isolators must be cleaned by reaching in an access opening and using cleaning equipment to clean surfaces that may extend the length, or be positioned at the other end, of the isolator. The mop adapter described herein and the hardware used with it can be used to clean such equipment.

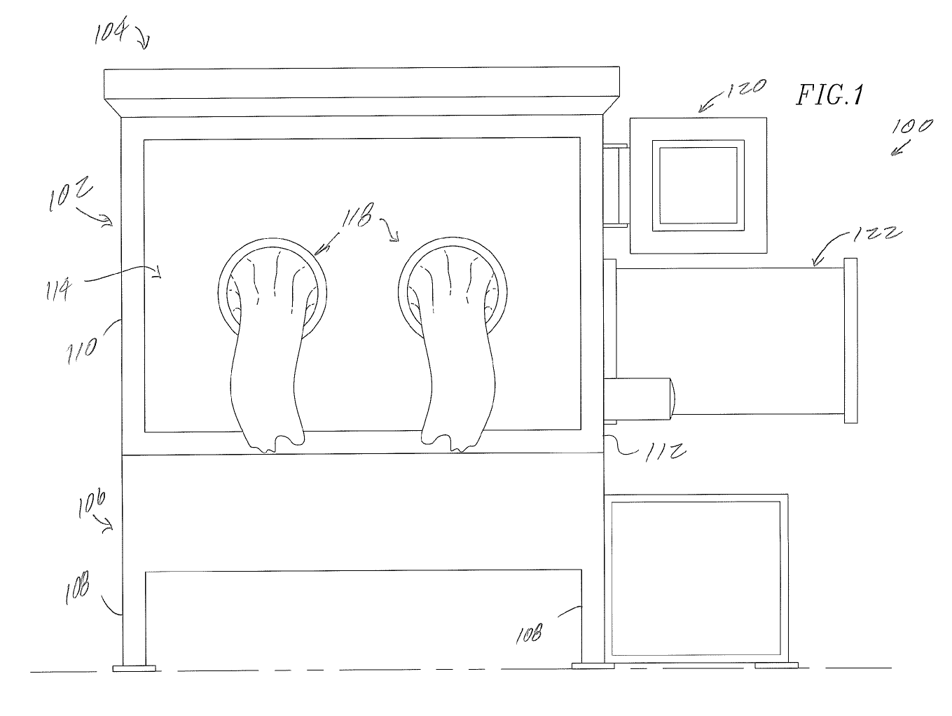

For purposes of illustration, a representative isolator will be shown and discussed in the context of a glovebox isolator, such as the isolator 100 shown in FIG. 1. However, it should be understood that the apparatus and methods described herein can be used for cleaning many types of equipment and surfaces other than the illustrated isolator. The isolator 100 includes an enclosure 102 supported within a frame including a top 104, a bottom 106 on legs 108, and a left side 110 and a right side 112. The enclosure 102 includes a see-through front 114, such as may be provided by a Plexiglas, Lexan or polycarbonate panel, and left and right side panels, the right side panel 116 shown in FIG. 15. While isolators may be configured in a number of ways, the isolator 100 example shown in FIGS. 1 and 15 and 16 has glove access adapters 118 in front, and a control panel 120 and an air lock 122 on the right side 112. The bottom 106 of the frame supports exhaust equipment (not shown), which may include a HEPA filtration assembly, duct assemblies and flow equipment. Mop adapters such as those described herein can be used to clean not only the outsides of isolators, but also inside surfaces of the isolators.

The outside of the isolator can be cleaned by applying a cleaning solution to a mop material or wipe material and wiping the exposed surfaces of the isolator. Typically, the sides of the isolator are easily accessible, but the top and bottom of the isolator are more difficult to access. A stool, ladder or other assist may be used to properly access the top of the isolator, while the bottom of the isolator may be accessed by stooping, kneeling or crouching down to reach the bottom of the isolator.

The inside of the isolator can be cleaned by passing a mop or wipers through the air lock 122 with a desired cleaner and bringing them into the enclosure using the glove adapters 118. The mop material or wipers are then used to clean the inside surfaces of the isolator.

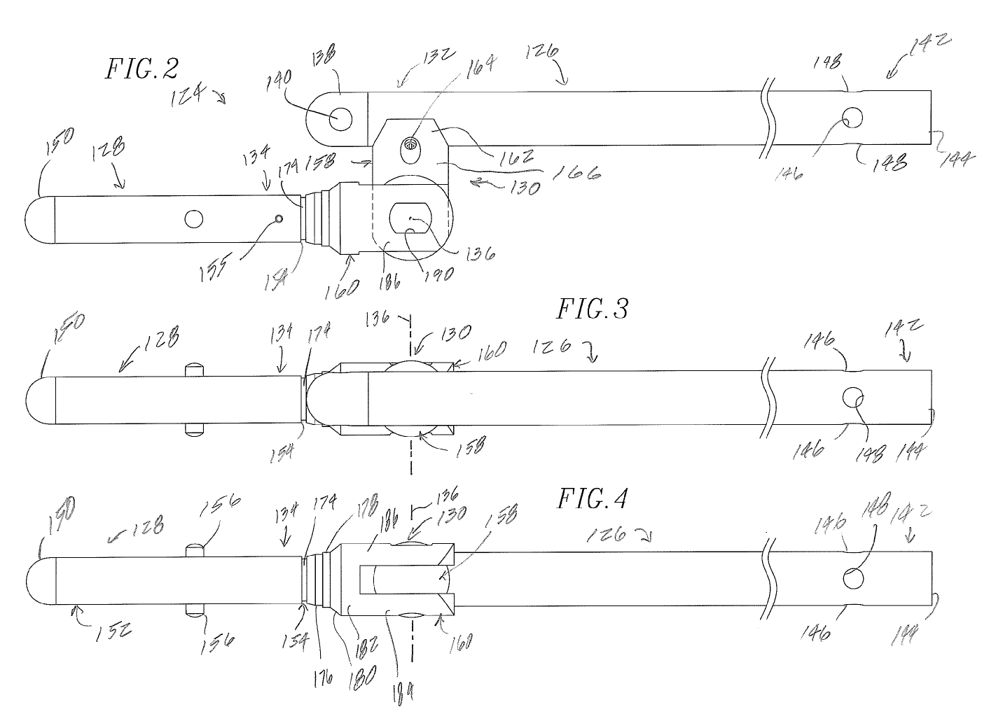

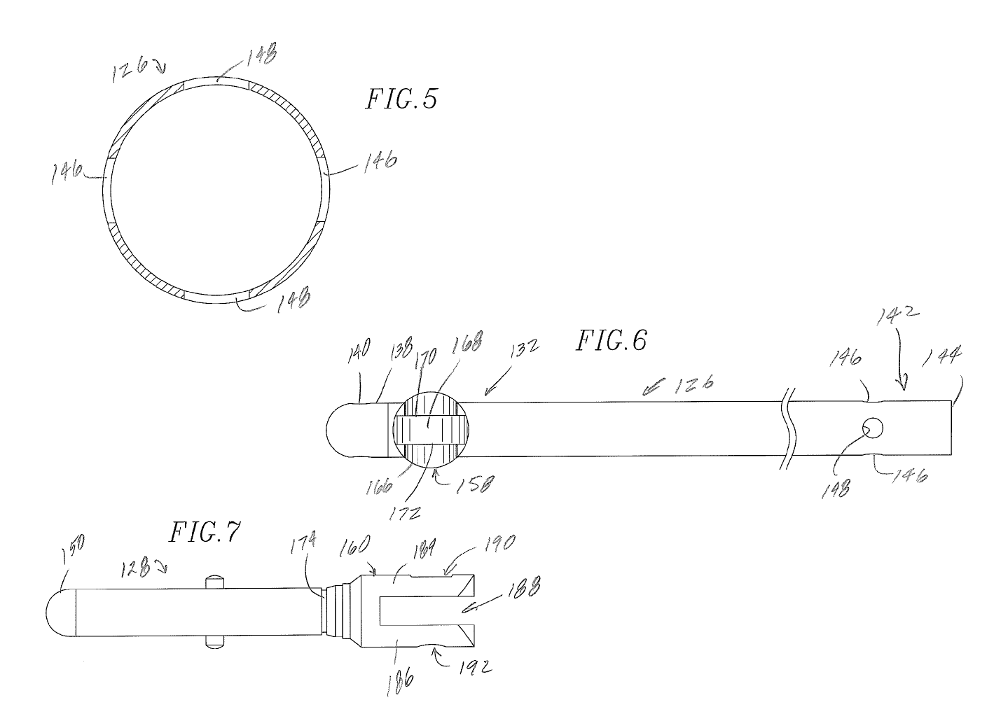

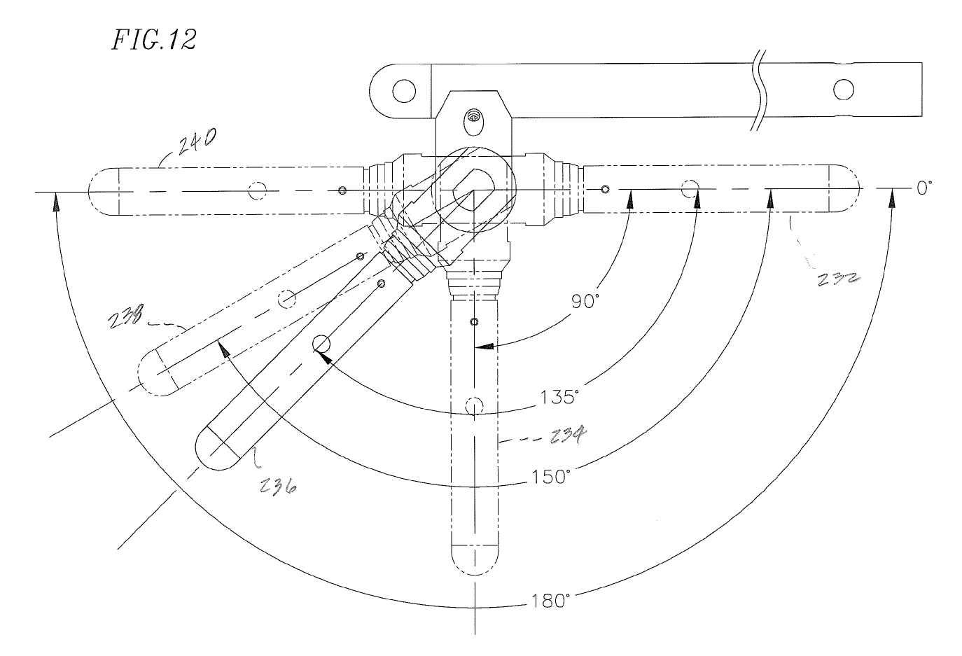

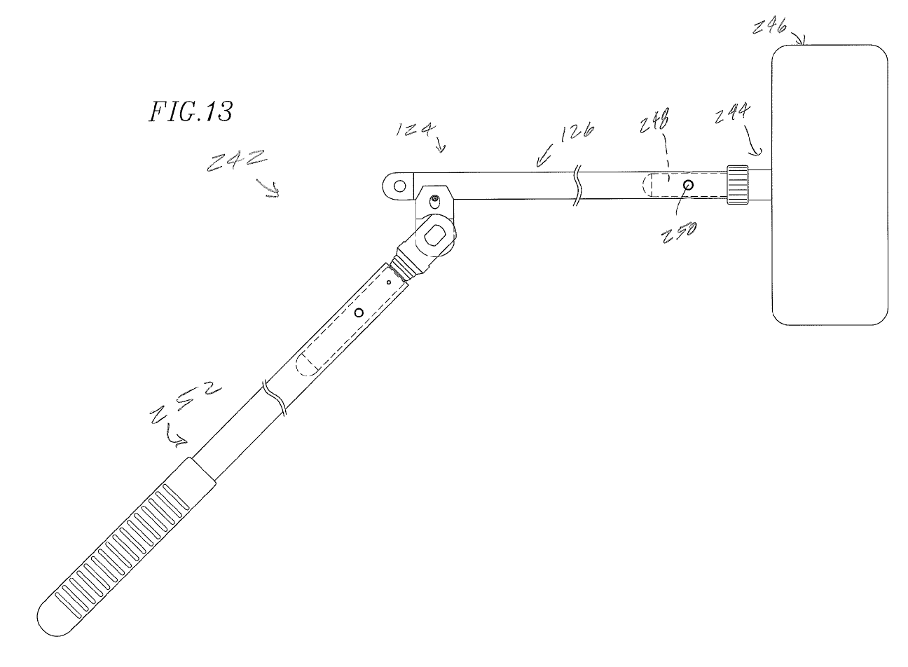

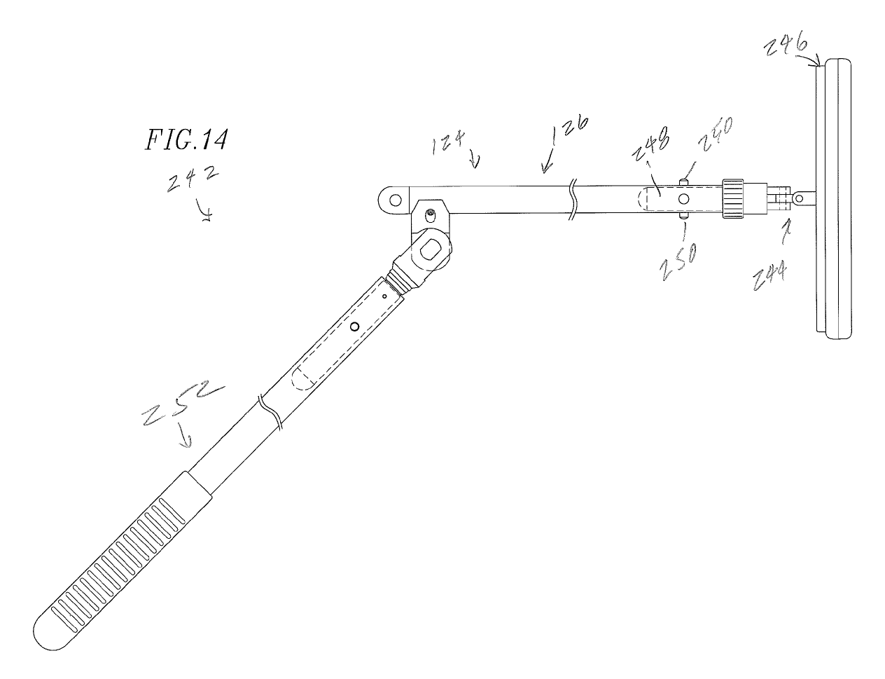

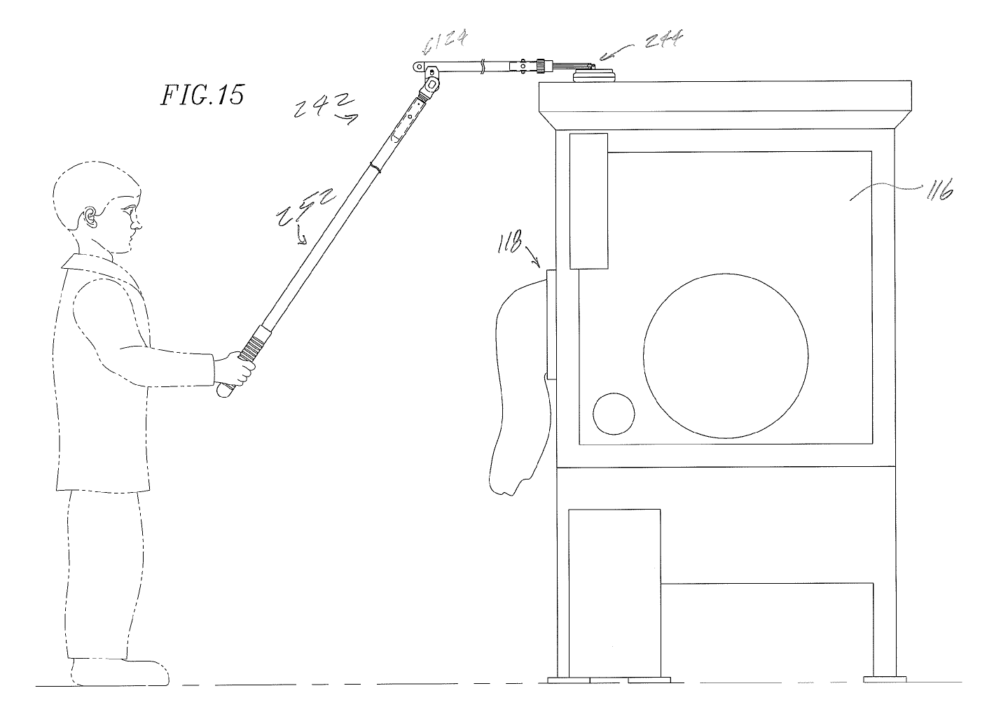

A mop adapter, such as one that may be used with a mop assembly such as those shown in FIGS. 13-16, includes first and second linear elements coupled together through a hinge assembly. In one example, a mop adapter 124 (FIGS. 2-7) includes a first tubular element 126 and a second tubular element 128. A hinge assembly 130 connects a first end portion 132 of the first tubular element 126 to a second end portion 134 of the second tubular element 128. The hinge assembly allows the first and second tubular elements to pivot relative to each other about an axis 136, so that the first and second tubular elements can be positioned at selected angles relative to each other, as desired. In the example shown in FIGS. 2-7, the hinge assembly surfaces are configured to allow the first and second tubular elements to extend at angles relative to each other anywhere from 0-180 degrees (see, for example, FIG. 12). The hinge assembly can be configured to allow other ranges of angles.

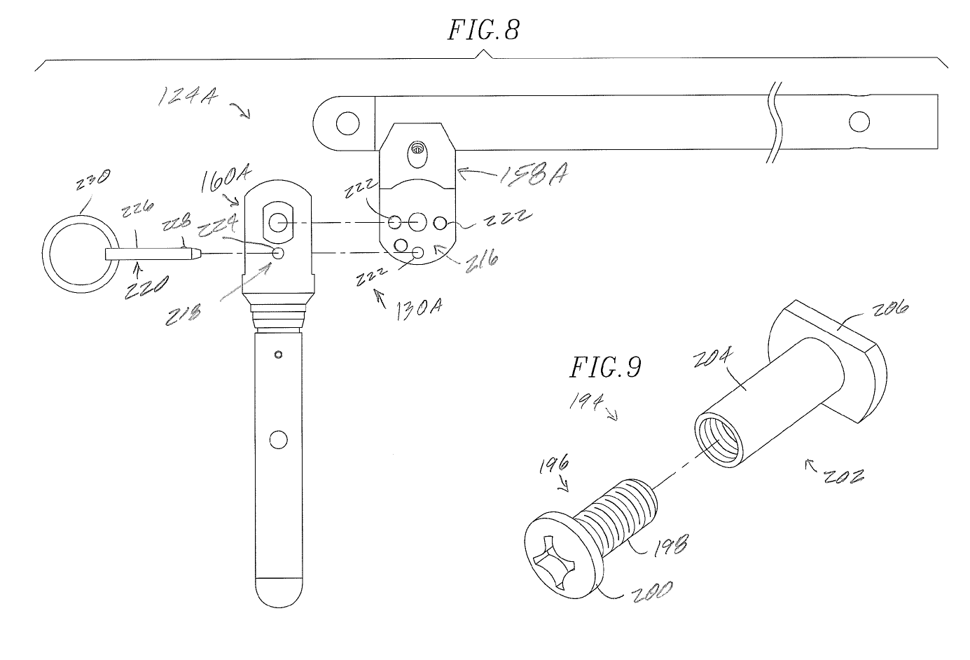

In the example shown in FIGS. 2-7, the first tubular element is substantially circular in transverse cross-section (see FIG. 5) and includes an end cap 138 inserted into the open end of the first end portion 132, to close the opening. In the present example, the end cap 138 is secured in the opening through fasteners used to secure the hinge assembly 130 to the first end portion 132. The end cap 138 includes a shaft defining an opening 140 extending through the end cap 138 in a direction substantially parallel to the hinge axis 136. The opening 140 allows the use of attachment rings or other components.

The first tubular element 126 extends substantially linearly to a second end portion 142 opposite the first end portion 132. Over the length of the tubular element 126, the tubular element is generally right circular cylindrical and hollow. The second end portion 142 terminates at a circular opening 144, into which a mop head adapter, mop element, other mop adapter 124 or other component can be inserted. The length of the first tubular element may be selected as desired, but in the present example is longer than the length of the second tubular element 128.

In the present example of the first tubular element 126, the second end portion 142 includes a first pair of connection elements 146 for interacting with one or more complementary connection elements on a component to be coupled to the mop adapter 124. Typically, the complementary connection elements will engage one or both of the connection elements 146, and in the examples described herein, the component will have a portion extending into the opening 144. The adapter 124 thereby reliably supports the component. In the examples described herein, the component is a mop head adapter or another mop adapter 124. The connection elements 146 can be used to fix the orientation of the mop head adapter or second mop adapter 124 relative to the first tubular element 126, and therefore its mop adapter 124. In the present examples, the connection elements 146 are substantially circular holes arranged substantially diametrically opposite each other on an axis substantially parallel to the hinge axis 136.

The second end portion 142 of the first tubular element 126 includes a second pair of connection elements 148. The second pair of connection elements 148 interact with one or more complementary connection elements on a component to be coupled to the mop adapter 124. The component may be the same component as was coupled to the mop adapter with connection elements interacting with the connection elements 146. Alternatively, the component may be a different component. In the examples of the mop adapters described herein, the connection elements 148 are substantially circular holes arranged substantially diametrically opposite each other on an axis substantially perpendicular to the hinge axis 136, and perpendicular to the line on which the connection elements 146 are positioned. The first and second pairs of connection elements 146 and 148, respectively, can be used to position an attached component at different positions perpendicular to one other. Other connection elements than circular openings can be used to orient and secure components joined to the mop adapter 124.

In the example shown in FIGS. 2-7, the second tubular element 128 is substantially circular in transverse cross-section and includes an end cap 150 inserted into the open-end of a first end portion 152 of the second tubular element 128, to close the opening. In the present example, the end 150 is secured in the opening through rivets or other fasteners (not shown). The second tubular element extends substantially linearly from the first end portion 152 to the second end portion 134 opposite the first end portion 152. Over the length of the second tubular element 128, it is generally right circular cylindrical and hollow. The second end portion 134 terminates at a circular opening 154, into which another portion of the hinge assembly 130 is inserted and secured, such as through rivets, split roll pins or other fasteners 155 (FIG. 2). The length of the second tubular element may be selected as desired, but in the present example is shorter than the length of the first tubular element 126. The length of the second tubular element is preferably sufficient to reliably support a handle, other mop adapter or other component that may be secured to the second tubular element.

In the present example of the second tubular element 128, the tubular element includes a third pair of connection elements 156 for interacting with one or more complementary connection elements on a component to be coupled to the mop adapter 124 through the second tubular element 128. Typically, the complementary connection elements will engage one or both of the connection elements 156, and in the examples described herein, the component will have a portion extending over the second tubular element 128 in such a way as to allow the third connection elements 156 to engage complementary connection elements on the other component. In the examples described herein, the complementary connection elements on the other component will be openings into which the third connection elements 156 extend for engagement. In one example, the other component may be a second mop adapter 124 wherein the third connection elements 156 engage a first or second pair of openings in a second end portion of a first tubular element. In the present examples, the third pair of connection elements are snap buttons positioned diametrically opposite each other and biased radially outward of each other along a line substantially parallel to the hinge axis 136. Other connection elements than snap buttons can be used to orient, secure and position components joined to the mop adapter 124 at the second tubular element 128.

The hinge assembly 130 includes first and second hinge elements 158 and 160, respectively, pivoting relative to each other about the hinge axis 136. The first hinge element 158 includes a saddle portion 162 (FIG. 2) mounted and secured to the outside of the first end portion 132 of the first tubular element 126, for example through fasteners 164 that can also be used to the secure the end cap 138. One fastener is shown in FIG. 2 while a second fastener is applied on the opposite side of the first hinge element 158.

The first hinge element 158 includes a body 166 extending substantially perpendicular away from the second end portion 132 of the tubular element to a pivot support portion 168 (FIG. 6). The pivot support portion extends outward away from the body 166 and includes substantially flat side faces 170 and 172, each of which extend in directions substantially parallel to the first tubular element 126. The orientation of the flat side faces 170 and 172 are configured to allow the hinge element and therefore the second tubular element to pivot relative to the first tubular element in a plane parallel to the first tubular element 126 and perpendicular to the hinge axis 136. The surface area defined by the first and second surfaces 170 and 172 are preferably sufficient to adequately support the second hinge element 160, and to minimize any movement of the second hinge element 160 out of a plane perpendicular to the hinge axis 136. The first hinge element 158 includes an opening (not shown) connecting the substantially flat side faces 170 and 172 for receiving a hinge pin, pivot pin or other component for securely allowing the first and second hinge elements to pivot relative to each other. In the present examples, the opening receives a fastener assembly.

The second hinge element 160 includes a substantially cylindrical post 174 (FIGS. 2-4 and 7) extending into and secured to the second end of the second tubular element 128 through the split roll pins 155. The post 174 supports the second tubular element 128 on the hinge assembly. The post 174 extends outward from a first shoulder 176 on the second hinge element having a diameter larger than the diameter of the post 174. The first shoulder 176 extends between the post 174 and a second, larger shoulder 178, which in turn joins a third, outwardly-sloping shoulder 180 to join a body portion 182. The body portion 182 is substantially circular in cross-section transverse to the second tubular element 128.

The second hinge element includes a pair of split plates 184 and 186 (FIGS. 2, 4 and 7) forming a gap 188 there between (FIG. 7). The gap has a width substantially identical to the thickness of the pivot support portion 168, and is otherwise configured to allow a full range of pivoting in a plane through an angle of approximately 180 degrees (see, for example, FIG. 12). The plates 184 and 186 extend on respective sides of the pivot support portion 168 and are supported thereby. Each of the plates 184 and 186 include respective openings (not shown) for receiving the fastener assembly about which the hinge elements pivot.

In the present examples, the first plate 184 includes a non-circular recess 190 (FIGS. 2 and 7) for retaining a portion of a fastener assembly and substantially preventing rotation of that portion of the fastener assembly relative to the second hinge element. The second plate 186 includes an opening 192 (FIG. 7) for receiving a fastener in the faster assembly. The hinge assembly is preferably formed from Delrin or other low friction material suitable for cleanroom applications and for reliable pivoting of the hinge element with respect to each other. The material may be such as to allow fixing of the two hinge elements with respect to each other.

In one example of a fastener assembly, the fastener assembly 194 (FIG. 9) includes a threaded fastener 196 having a threaded shaft 198 and an engagement head 200. The engagement head 200 permits a suitable tool for threading the fastener 196 into a threaded component, such as a receiver 202. In the example shown in FIG. 9, the receiver 202 includes an internally-threaded sleeve 204 and a non-circular head 206. The head 206 of the receiver is complimentary to and rests in the non-circular recess 190 of the second hinge element so that the receiver 202 does not pivot relative to the second hinge element. The sleeve 204 extends from the recess 190 through the openings in the first and second hinge elements part way to the opening 192 in the second plate 186 (FIG. 7), where the fastener 186 is threaded into the sleeve 204. The head 200 of the fastener bears against the second plate 186, and when tightened down into the receiver 202, may be sufficient to lock the first and second hinge element in position relative to each other, and thereby the first and second tubular elements with respect to each other.

In another example of a fastener assembly, a fastener assembly 208 (FIG. 11) includes the receiver 202 having the threaded sleeve 204 and the head 206. The threaded fastener for engaging the receiver 202 includes a manual fastener element 210 having a threaded shaft 212 having a manual grip 214 suitable for turning the fastener by hand. The assembly, configuration and use of the fastener assembly 208 is otherwise substantially the same as or identical to that for the fastener assembly 194. In another example, the manual grip 214 may be replaced by a thumb screw or wing nut head for manually securing the fastener assembly and therefore the hinge assembly.

In any of the mop adapter assemblies described herein, the first and second tubular elements can be locked at a given angular orientation relative to each other. In the examples described herein, the tubular elements are locked relative to each other by locking the first and second hinge elements relative to each other. In the example of the assembly shown in FIG. 8, the mop adapter 124A includes a locking element for the hinge assembly for releasably locking the mop adapter in each of several different angular configurations. Specifically, the hinge assembly 130A includes first and second hinge elements 158A and 160A having locking elements 216, 218 and 220 (FIG. 8). In the present example, the locking element 216 includes a plurality of openings 222, the locking element 218 includes a pair of aligned openings 224 (only one of which is shown in FIG. 8), and a locking element 220 includes a pin 226 having a biased detent 228 and a manual ring 230. The locking elements 216, 218 and 220 together can be used to releasably lock the mop adapter in a desired angular configuration. For example, in the configuration represented in the exploded view of FIG. 8, the first and second tubular elements are oriented at 90 degrees relative to each other, and they can be locked in that angular configuration by inserting the pin 226 through the opening 218 (or openings 218 in both split plates 184 and 186) and lower opening 222 to lock the hinge assembly. The pin 226 can be removed and the second tubular element pivoted relative to the first tubular element to another selected position and locked again using the pin 226. Openings 222 can be positioned as desired on the first hinge element 158A to provide the desired angular orientations. Some of the possible angular orientations are represented in FIG. 12, wherein the second tubular element is shown at zero degrees 232, at 90 degrees 234, at 135 degrees 236, at 150 degrees 238 and at 180 degrees 240. Other angular orientations are possible.

Fixing of the angular orientations can be achieved through multiple openings 222 in the first hinge element 158A and a single opening 224 in the second hinge element, or they can be achieved through multiple openings in the second hinge element and a single opening in the first hinge element. Alternatively, they can be achieved through multiple openings in both of the first and second hinge elements. The angular orientations can be discrete positions, or they can be positions along a continuum. Angular orientations along a continuum can be achieved through frictional engagement between the hinge elements, for example through the fastener assemblies described with respect to FIGS. 9 and 11.

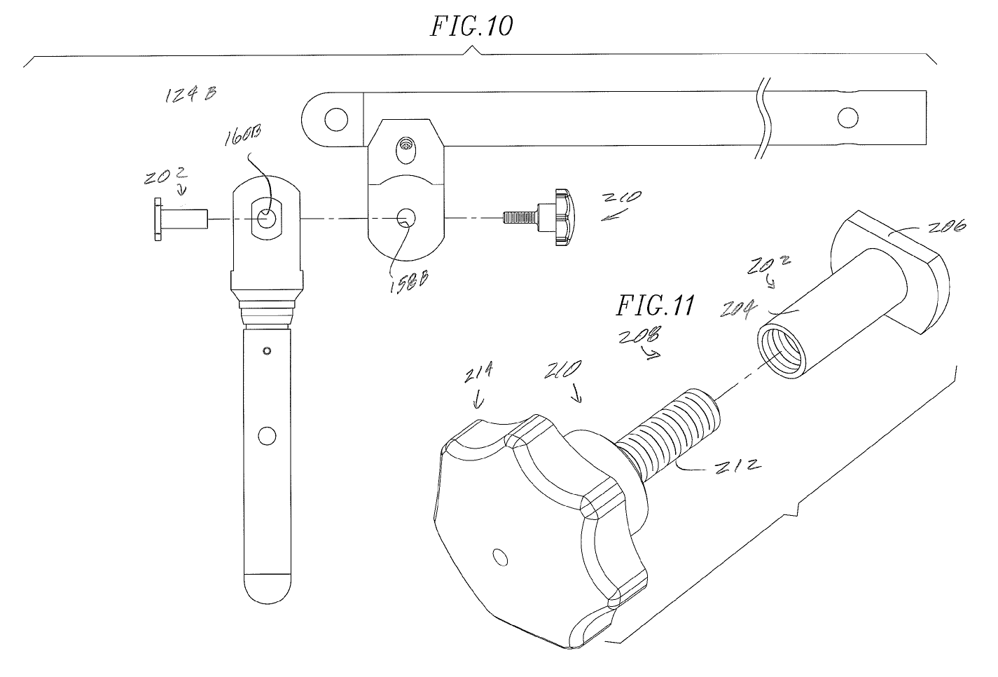

As shown in FIG. 10, the mop adapter 124B can be secured in various angular positions through the fastener assembly 208. The receiver 202 extends through the corresponding openings 158B and 160B, corresponding to the openings described above with respect to the hinge assembly 130, and the manual fastener element 210 is threaded into the sleeve 204. Because of the relative dimensions of the first and second hinge elements and tightening down the manual fastener element 210, frictional engagement between the first and second hinge elements can secure the angular position of the first and second tubular elements.

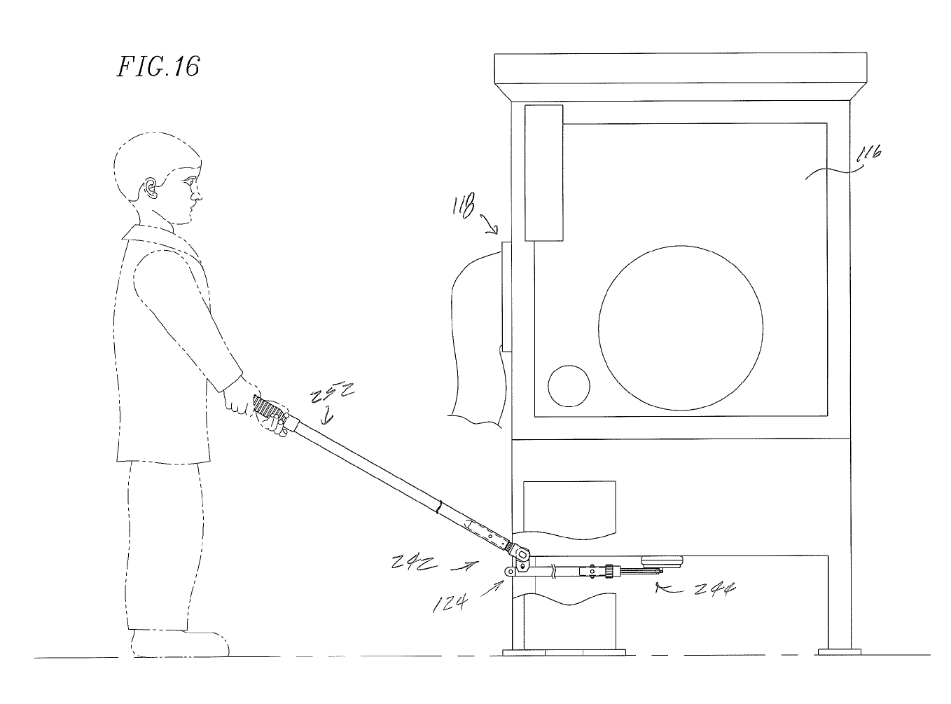

The mop adapters 124 described herein can be used with one or more other components to form a mop assembly 242 (FIGS. 13 and 14). The mop assembly 242 includes a mop head adapter 244 having a mop head 246. The mop head 246 can take a number of configurations, as known to those skilled in the art. The mop head adapter can also take a number of configurations, but in the examples shown in FIGS. 13 and 14, the mop head adapter includes a tubular element 248 extending into the opening end 144 of the first tubular element 126. The mop head adapter includes a pair of snap buttons 250 for engaging the corresponding openings in the first tubular element 126. With a mop head adapter assembled with a mop adapter 124, the relative positioning of the snap buttons 250 with corresponding connecting elements on the first tubular element 126 determines the orientation of the mop head adapter relative to the mop adapter 124. In the example shown in FIG. 13, the snap buttons 250 are positioned to engage and extend into corresponding connection elements in the form of the openings 146 in the second end portion of the first tubular element. With a universal joint for the mop head adapter 244 (see FIG. 14), the mop head 246 can take the configuration shown in FIG. 13.

The mop assembly 242 shown in FIGS. 13 and 14 can, though it need not, include a handle 252. The handle is mounted through connection elements such as a pair of holes corresponding and complimentary to the snap buttons 156 on the second tubular element 128 of the mop adapter 124. The handle 252 extends over the second tubular element, and may be any length desired.

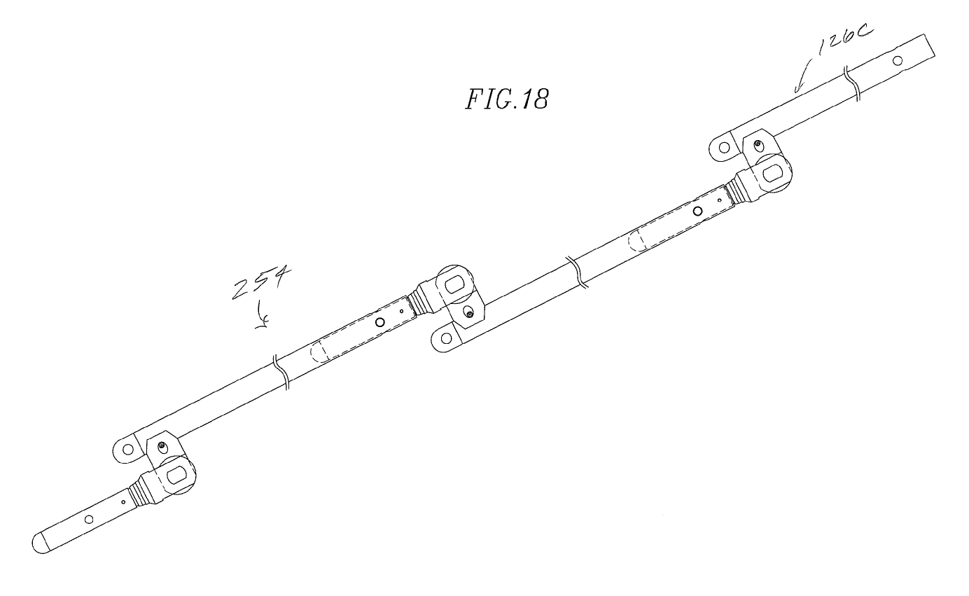

In the example of the mop assembly 242 shown in FIG. 13, the mop head 246 orientation can be advantageously used to clean the inside surfaces of an isolator, such as the isolator 100 shown in FIG. 1, as well as other surfaces. For example, where the handle 252 is a short handle, or is omitted, the mop assembly 242 can be passed through the air lock 122 (FIG. 1). The technician or operator can then manipulate the mop assembly 242, having the mop head 246 shown in the configuration of FIG. 13 to clean the interior surfaces of the isolator. With a mop head 246 in the configuration shown in FIG. 13, the mop assembly can be used to clean the vertical surfaces of the inside of the isolator. Where the isolator has an extended length, a mop assembly with a mop head 246 in the configuration as shown in FIG. 13 can be used to clean the inside vertical surfaces with relative ease using a mop assembly having more than one mop adapter 124 connected together (see FIGS. 17 and 18 for example).

In a mop assembly 242 with a mop head and adapter positioned on a mop adapter 124 as shown in FIG. 14, with a snap buttons 250 extending into and engaging the second pair of openings 148 in the first tubular element 126, the mop assembly can be used to clean horizontal surfaces with relative ease. Additionally, with more than one handle adapter 124 connected together and the mop head and mop head adapter positioned on the mop adapter as shown in FIG. 14, the mop assembly 242 can more easily clean tight quarters having high walls and ceilings, such as short hallways, entry ways and the like. Such areas may be difficult to clean using long-handled mops.

Changing positions of the mop head adapter between the configuration shown in FIG. 13 and the configuration shown in FIG. 14 is relatively easy. Even with the assembly in an isolator, the mop head adapter is simply rotated 90 degrees in the desired direction after the snap buttons 250 are depressed into the interior of the first tubular element 126. The snap buttons are then released from the interior of the first tubular element 126 when they align with the next pair of openings. Other configurations and structures for fixing the relative orientation between the mop adapter 124 and mop head adapter 244 can be used.

The configuration of the mop assembly shown in FIG. 14 is particularly useful for reaching and cleaning relatively inaccessible areas without additional stress or strain on the user. For example, with a sufficiently long handle 252 and the hinge assembly locked at approximately 135 degrees, the user can relatively easily clean the top of the isolator or the top surfaces of other equipment that was previously more difficult to clean with conventional equipment. The top surfaces can be cleaned by the operator without having to unduly lift the arms or keep the arms raised during cleaning. Additionally, with a sufficiently flexible universal jointed mop head adapter, the mop assembly can be moved about a significant amount while maintaining the mop head flat against the top surface of the isolator or other piece of equipment.

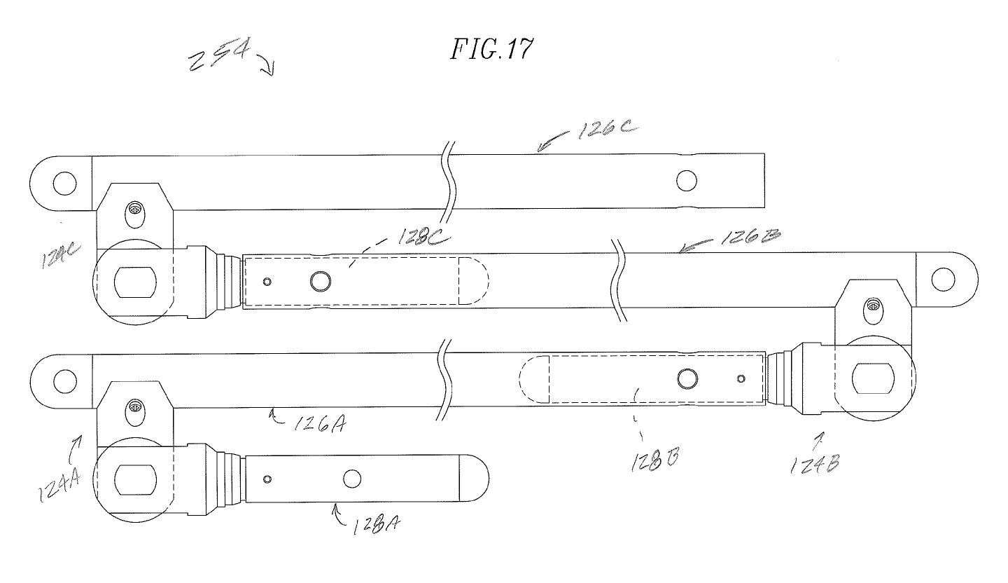

The configuration of the mop assembly shown in FIG. 14 is also useful for reaching and cleaning underneath equipment, which was formerly more difficult to access for cleaning with conventional equipment. The mop assembly allows access of such areas without additional stress or strain on the user. For example, with a suitable handle 252 and the hinge assembly locked at approximately 150 degrees (see FIGS. 12 and 16), the user can relatively easily clean the bottom of the isolator or bottom surfaces of other equipment as well as floor surfaces (such as by pivoting the mop head relative to its adapter to face downward) under equipment previously more difficult to clean with conventional equipment. In some situations, the spacing between the floor and the bottom of the overlying equipment may be 4-6 inches. Such surfaces can be cleaned by the operator without having to unduly bend at the waist or at the knees, and without having to unduly reach or hold the arms at uncomfortable positions. Also, a mop assembly having a sufficiently flexible universal jointed mop head adapter allows the user to move the mop assembly around while keeping the mop head relatively flat against the surface to be cleaned.

With the mop adapter 124 as described herein, two or more mop adapters can be assembled into an articulated assembly 254 (FIGS. 17 and 18) formed by inter-connecting a plurality of mop adapters. For example, the assembly 254 is formed by inter-connecting the first tubular element 126A of a mop adapter 124A with a second tubular element 128B of a second mop adapter 124B. The first tubular element 126B is in turn connected to a second tubular element 128C of a third mop adapter 124C. The first tubular element 126C can then be used to mount a mop head adapter, for example in either of the orientations shown in FIGS. 13 and 14. The assembly 254 shown in FIG. 17 can be conveniently placed inside an isolator through the air lock 122 and thereafter unfolded to the extent desired for cleaning the inside of the isolator. Additionally, a handle of the appropriate length or other configuration can be mounted on the second tubular element 128A of the assembly 254.

In the fully expanded configuration of the assembly 254, such as shown in FIG. 18, the assembly 254 can be used with a suitable mop head and mop head adapter attached, such as to the first tubular element 126C in the configuration represented in FIG. 14. In this configuration, the expanded configuration of the assembly 254 can be used to clean ceilings and walls in confined areas. For example, in short hallways, pass-throughs and entry ways, the walls can be cleaned from top to bottom by folding and unfolding the articulated assembly, and without having to disconnect the mop head from the assembly 254. The cleaning can be done often in a single sweep. In conventional assemblies, a long handle used to clean the upper portions of walls in such confined spaces would need to be removed from the mop head in order to clean the wall closer to the floor. With the assembly 254 shown in FIGS. 17 and 18, the mop head need not be disconnected to clean the entire surface of the wall. Multiple assembled mop adapters can also be used to conveniently clean other surfaces.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A mop adapter for connecting to a mophead adapter, the mop adapter comprising:
a first linear element extending from a first end portion to a second end portion and wherein the second end portion includes a plurality of connection elements configured to connect to a complimentary mop head adapter and wherein the plurality of connection elements are configured to allow connection of a mophead adapter in a first orientation and in a second orientation perpendicular to the first orientation;
a second linear element having a first end portion and a second end portion; and
a hinge element extending between and mounted to the first end portion of the first linear element and to the second end portion of the second linear element.

2. The mop adapter of claim 1 further including connection elements on the first end portion of the second linear element.

3. The mop adapter of claim 2 wherein the hinge element permits movement of the first and second linear elements about a hinge axis relative to each other and wherein the connection elements on the first end portion of the second linear element are oriented in a direction parallel to the hinge axis.

4. The mop adapter of claim 2 the connection elements include a first configuration for mounting a mophead adapter so as to be oriented perpendicular to the hinge axis and a second configuration for mounting a mophead adapter so as to be oriented parallel to the hinge axis.

5. The mop adapter of claim 1 further including a locking element for locking the first and second linear elements relative to each other.

6. The mop adapter of claim 5 wherein the locking element is configured for locking the first and second linear elements together at a 90 degree angle.

7. The mop adapter of claim 5 wherein the locking element is configured for locking the first and second linear elements together at a 45 degree angle.

8. The mop adapter of claim 5 wherein the locking element is configured for locking the first and second linear elements together at a 30 degree angle.

9. The mop adapter of claim 5 wherein the locking element is configured for locking the first and second linear elements together with a locking pin.

10. The mop adapter of claim 5 wherein the locking element is configured for locking the first and second linear elements together with a threaded bolt.

11. The mop adapter of claim 10 wherein the locking element includes a handle on the threaded bolt.

12. A mop adapter for connecting to a mop head adapter, the mop adapter comprising:
a first tubular element having a first end portion and a second end portion;
a second tubular element having a first end portion and a second end portion;
a hinge element coupling the first end portion of the first tubular element to the second end portion of the second tubular element and having a pivot axis;
a first pair of coupling elements in the second end portion of the first tubular element and spaced apart from each other in a direction parallel to the pivot axis, and a second pair of coupling elements in the second end portion of the first tubular element and spaced apart from each other in a direction substantially perpendicular to the pivot axis;
a third pair of coupling elements in the first end portion of the second tubular element.

13. The mop adapter of claim 12 wherein the third pair of coupling elements are spaced apart from each other in a direction substantially parallel to the pivot axis.

14. The mop adapter of claim 12 wherein the coupling elements include detent pins.

15. The mop adapter of claim 12 wherein the first tubular element is longer than the second tubular element.

16. The mop adapter of claim 12 wherein the hinge element includes a locking element configured to releasably lock the first and second tubular elements relative to each other.

17. The mop adapter of claim 16 wherein the locking element is configured to lock the first and second tubular elements at different angles relative to each other.

18. The mop adapter of claim 17 wherein the angles include 90 degrees, 135 degrees and 180 degrees.

19. The mop adapter of claim 16 wherein the locking element is a removable pin.

20. The mop adapter of claim 16 wherein the locking element is a threaded bolt with a handle.

21. A mop adapter for connecting to a mop head adapter, the mop adapter comprising:
a first linear tubular element having a first end portion and a second end portion, wherein the second end portion includes a first pair of connection elements extending parallel to a first line, and a second pair of connection elements extending substantially perpendicular to the first line;
a second linear tubular element having a first end portion and a second end portion, and wherein the first end portion includes a first pair of biased detent elements extending substantially parallel to the first line;
a hinge assembly having a first hinge portion mounted to the first end portion of the first tubular element and a second hinge portion mounted to the second end portion of the second tubular element and configured such that the first and second hinge portions pivot relative to each other about an axis substantially parallel to the first line, and wherein the hinge assembly includes a locking element configured to lock the first and second hinge portions relative to each other.
